(19) United States
(12) Patent Application Publication
(10) Pub. No.: US 2008/0085017 A1
(43) Pub. Date: Apr. 10, 2008

(54) Loudspeaker and microphone based on the principle of "The Center of Percussion"

(76) Inventors: Andrei Ilies, Lincolnwood, IL (US); Luminita Dragan, Lincolnwood, IL (US)

Correspondence Address: ANDREI ILIES, 7007 N. HAMLIN AVE., LINCOLNWOOD, IL, 60712, US

(21) Appl. No.: 11/328,611

(22) Filed: Jan. 10, 2006

(51) Int. Cl. H04R 25/00

(52) U.S. Cl. 381/150

(57) ABSTRACT

A transducer of electrical oscillations to mechanical oscillations or mechanical oscillations to electrical oscillations, mainly a loudspeaker or a microphone, having in general an elongated oscillating member attached by joints to a surrounding structure in areas of points or lines of specific dynamic balance, like one end, center of mass, center of equal rotational inertia, center of percussion about a certain axis of rotation. At least one actuator is mounted in the area of these balancing points or lines. In an alternative to the preferred embodiment of the invention, the oscillating member is built to incorporate at least one cavity filled with air or a fluid different from air or having a certain degree of vacuum in it. In an alternative to the preferred embodiment of the invention the transducer is placed in a position to favor the retention of a heat exchanging fluid, other than magnetic fluid, inside the actuator.

The incorporation of a coil other than circular targets the reduction of coil inductance to increase the transducer's performance.

A symmetrical constructed assembly brings about improved physical stability to voice coils.

### BACKGROUND OF THE INVENTION

This invention relates to loudspeakers and microphones of every type. In general any kind of electromechanical and mechanical transducers that can reach outside the acoustic range are to be considered.

The dynamic loudspeakers, having a voice coil placed in the gap of an electromagnet or permanent magnet are mainly of two categories. The first category is the cone type, flat radiator and the soft and hard domes. The second category is the planar speaker.

The main disadvantage of the first category is the predominant piston-like motion of the oscillating member. Their membrane is also very thin compared to their other dimensions, being highly transparent to the sound, allowing for the sound in opposition of phase, produced on the rear side of the oscillating member to cancel part of the sound produced on the front side of the speaker, diminishing the efficiency of the transducer.

The dynamic transducers can be compared to a physical pendulum. After ceasing of the driving force these transducers will have their membranes bounce before they come to a still-stand, just like the pendulum would. This bouncing is especially obvious in frequency and amplitude transitions. Even with considerable damping provisions, this phenomenon poses clear limitations on the transducer's performance. The bouncing takes place with a frequency of the value of the resonance frequency of the transducer itself. So, the transducer itself will introduce frequencies not present in reality in the message conveyed to it.

The planar loudspeakers have their oscillating members made in general of stiff, lower density material or an assembly of materials, having in general a substantial thickness compared to all other loudspeakers. This makes them overcome the setback of acoustic transparency of their membranes. Also, part of them favor the propagation of mechanical energy in form of transversal waves along and across their oscillating member. The efficiency of energy transfer is superior in this case because it happens with less dissipation due to inertial reaction of a relatively less concentrated mass of the oscillating member.

The disadvantage of a generally stiff and thick membrane is that it is not able to handle the propagation of transversal oscillations in two perpendicular directions without excessively stressing their body and introducing distortions over a permissible limit.

Certain designs of planar loudspeakers have adopted an elongated shape of the oscillating member, with noticeable advantages, but the unnecessary internal stressing of their poorly balanced membranes still brings about a high level of distortion.

The microphones, acting in reverse to the loudspeakers, in their same piston-like motion of their oscillating member are submitted to the same limitations as the loudspeakers.

It is known that the circular shape of the voice coil of dynamic transducers has the maximum inductance for a given length of conductor, a given length of coil, perimeter of coil and number of coil windings. By changing the shape of it, the same coil can be brought to lessen its inductance considerably, improving the transducer's response at higher frequencies.

There is an obvious need to improve the efficiency and accuracy of all acoustical transducers in particular and all of the electromechanical transducers in general. The present invention addresses these requirements.

### DESCRIPTION

### Brief Summary of the Invention

The present invention describes a loudspeaker having an oscillating member built in general of a relative thick, sound absorbing, stiff, lower density material, like balsa wood, plastic foam or a composite material. The shape of the oscillating member is in general elongated or at least can be associated in part of it to an elongated body. It can be a sheet, a plate or a body of regular or irregular form. A film can also be considered.

Due to its elongated shape, the oscillating member will favor the propagation of mechanical oscillations as transversal waves in the predominant direction of it, the longitudinal direction, while the oscillations in the direction of the width of the oscillating member are being kept minimal. The sound is created by a whipping action of the oscillating member on the mass of air in the proximity of its surface.

The present invention also describes a microphone, which presents an elongated member. The sound waves will bring a mainly transversal oscillation mode to the membrane, resulting in a more efficient energy transfer.

To attain a high fidelity of reproduction, regardless of its action as transducer of mechanical to mechanical oscillations, of mechanical to electrical oscillations or electrical to mechanical oscillations, in the preferred embodiment of the invention, the oscillating member of the transducer is attached to its surrounding supporting structure in a minimum number of joints. These joints can be pivoting elements or unidirectional flexing elements, placed in pairs, facing each other across the width of the oscillating member.

The flexible elements can also hold the oscillating member at one end or both ends, measured in the longitudinal direction of the oscillating member. The same called joints can be brackets on one side or both sides, back and front of the oscillating member, along the width of the oscillating member, resting on the oscillating member entirely or touching the oscillating member in a minimum number of points or lines of interest. These brackets are mounted onto the supporting structure.

Given its elongated shape, relative stiffness, as well its relative high rate of vibration with small amplitude compared to its length, it is safe to presume that the oscillating member behaves like a solid stick. It is obvious that, in this case, the most dynamically stable state will be reached if the oscillating member would be forced to swing around an axis, which could be, like in the preferred embodiment of the invention, one end of the oscillating member, a line through the center of mass of the entire oscillating member, or any conveniently chosen point or line along the oscillating member.

By choosing, in the preferred embodiment of the invention, to have the axis of rotation in the area of the first end of the oscillating member and the voice coil placed in the point where the rotational inertia of the part of the oscillating member between the first end of the oscillating member and that point about the axis of rotation will equal the rotational inertia of the remaining part of the oscillating member about the same axis of rotation, any movement induced in the area of the voice coil will not reflect into the axis of rotation. This very point is called “Center of Percussion” and is defined in the Webster Encyclopedia as: “The point on a rigid body, suspended so as to be able to move freely about a fixed axis, at which the body may be struck without changing the position of the axis.”

In an alternative to the preferred embodiment of the invention the center of mass of the entire oscillating member is considered to execute a translation movement while parts of the oscillating member on one side or both sides of the center of mass of the entire oscillating member are considered to swing around the center of mass of the entire oscillating member. The principle of the center of percussion can be applied to one or both of these two parts of the oscillating member, having generated this way one or two lines across the length of the oscillating member where the dynamic forces balance themselves in the way of not inducing reactions in the line of the center of mass of the entire oscillating member, or where the reaction is under the form of a sting, meaning that for one oscillation of the voice coil, there will be only one oscillation of that very point and vice-versa.

In a second alternative to the preferred embodiment of the invention the two sides apart from the center of mass of the entire oscillating member can be considered as moving their centers of mass in a translation and only their parts outside from their centers of mass towards the ends of the entire oscillating member will rotate around the respective centers of mass of the very parts of the oscillating member. This state will bring about two additional points where the inertial forces show balance in a particular case, that is, no reaction in the center of mass of the very parts of the entire oscillating member on each side of the center of mass of the entire oscillating member. These two points, if used as locations for joints, would bring about an outstanding dynamic stability for the entire oscillating member, translated in acoustic terms, the highest quality of transferred vibrations attainable from the system. The voice coil in this case is best placed in the center of mass of the entire oscillating member.

In a third alternative to the preferred embodiment of the invention, the places of the joints from the second alternative to the preferred embodiment of the invention are taken by voice coils on the line of the respective pair of joints. In addition, one pair of joints is installed in the center of mass of the entire oscillating member and two pairs of joints or one flexible element are installed at the two very ends of the entire oscillating member.

Another alternative to the preferred embodiment of the invention is to create a cavity or cavities inside the oscillating member to enable a closer control of density and distribution of mass along the system. Also, the replacement of the air inside the cavity or cavities with a suitable fluid will improve the sound absorption inside the oscillating member. A rubber bladder is installed in the proximity of the oscillating member, connected to the cavity or cavities to compensate for the volume variation of the gas due to changes in temperature. Also, creating a certain degree of vacuum in the cavity or cavities inside the oscillating member or membrane will bring an improved sound separation between the different targeted areas of the system.

In another alternative to the preferred embodiment of the invention a loudspeaker is held in a horizontal position with the gap of the magnet assembly surrounding the voice coil facing upwards. In this position, having the central part of the magnet assembly provided with an opening that communicates with the front side of the oscillating member, the cavity of the magnet assembly can be filled with a heat exchanging fluid other than magnetic fluid. The submerged voice coil will be able to handle increased power loads.

In another alternative to the preferred embodiment of the invention a stream of gas like air is sent across the coil of a dynamic loudspeaker in order to improve the cooling of the coil. In another alternative to the preferred embodiment of the invention, the round shaped coil of a dynamic transducer is changed to a out of circular shape in order to decrease the inductance of the coil, and this way decrease the inductive reactance of the coil at high frequencies, targeting an increase of output and improved phase response.

In another alternative to the preferred embodiment of the invention, the voice coil form, so called former, is placed between two successive layers of the voice coil. The improved connection of the voice coil elements in this case avoids the exfoliation of the coil windings due to thermal expansion and sealant failure, rendering the voice coil physically indestructible.

The result is an unprecedented quality, efficiency and throughput of the transducer as presented in the preferred embodiment of the invention and further accomplished by drawings that illustrate the principle of the invention.

### BRIEF DESCRIPTION OF DRAWINGS

The various advantages and features of the invention will be further brought forward by the following discussion taken in conjunction with the set of drawings in which:

FIG. 1a is a rear view of the electromechanical transducer, in particular a loudspeaker or a microphone, as the preferred embodiment of the invention.

FIG. 1b is a left view of FIG. 1a.

FIG. 1c is a partial section on the line A-A of FIG. 1a.

FIG. 2a is a rear view of the electromechanical transducer, in particular a loudspeaker or a microphone, as an alternative to the preferred embodiment of the invention.

FIG. 2b is a left view of FIG. 2a.

FIG. 2c is a right view of FIG. 2a.

FIG. 3a is a rear view of the electromechanical transducer, in particular a loudspeaker or a microphone, as an alternative to the preferred embodiment of the invention.

FIG. 3b is a left view of FIG. 3a.

FIG. 4a is the rear view of the electromechanical transducer, in particular a loudspeaker or a microphone, as an alternative to the preferred embodiment of the invention.

FIG. 4b is the left view of FIG. 4a.

FIG. 5a is a section on the line D-D in FIG. 5c.

FIG. 5b is a section on the line B-B in FIG. 5a.

FIG. 5c is the right view of the oscillating member of the electromechanical transducer, as an alternative to the preferred embodiment of the invention.

FIG. 6a is a section on the line F-F of FIG. 6c.

FIG. 6b is a section on the line E-E in FIG. 6a of the entire oscillating member.

FIG. 6c is the right view of the oscillating member of the electromechanical transducer, as an alternative to the preferred embodiment of the invention.

FIG. 7a is the rear view of the electromechanical transducer, in particular a loudspeaker, as an alternative to the preferred embodiment of the invention.

FIG. 7b is a partial section on the line G-G of FIG. 7a.

FIG. 8a is a section on the line H-H of FIG. 8b.

FIG. 8b is the rear view of the electromechanical transducer, in particular a loudspeaker, as an alternative to the preferred embodiment of the invention.

FIG. 9 is a simplified drawing showing a side view of a capacitor type transducer, loudspeaker or microphone, as an alternative to the preferred embodiment of the invention.

FIG. 10 is a simplified drawing showing a side view of a capacitor type transducer, loudspeaker or microphone, as an alternative to the preferred embodiment of the invention.

FIG. 11 is a simplified drawing showing a side view of a magnetic type microphone, as an alternative to the preferred embodiment of the invention.

FIG. 12 is a cross-section through a ribbon type transducer, loudspeaker or microphone.

FIG. 13 is a simplified drawing showing a side view of a resistive type microphone, as an alternative to the preferred embodiment of the invention.

FIG. 14 is a simplified drawing showing a side view of a piezoelectric transducer, loudspeaker or microphone, as an alternative to the preferred embodiment of the invention.

FIG. 15a is the drawing of a cross-section along line K-K from FIG. 15b showing a voice coil of a dynamic loudspeaker or microphone as an alternative to the preferred embodiment of the invention.

FIG. 15b is a top view of FIG. 15a.

FIG. 16a is a front view of the voice coil of a dynamic loudspeaker or microphone as an alternative to the preferred embodiment of the invention.

FIG. 16b is a top view of FIG. 16a.

### DETAILED DESCRIPTION OF THE INVENTION

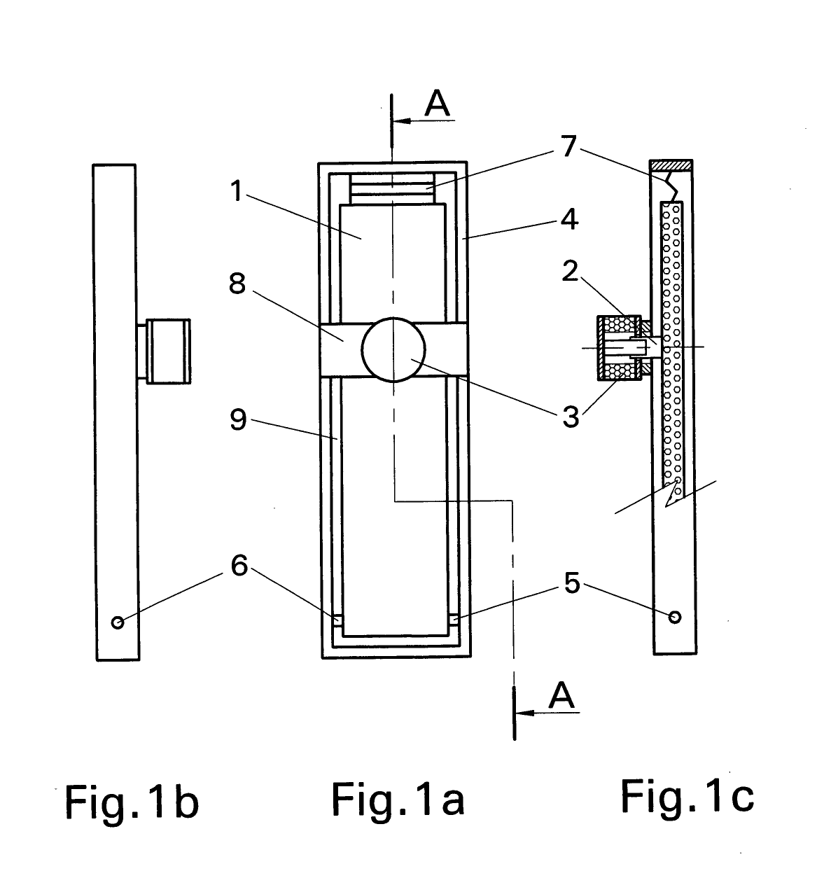

FIG. 1a is showing the electromechanical transducer, in particular a loudspeaker or a microphone as the oscillating member (1) surrounded by the solid frame (4). The magnet assembly (3) is mounted on the bridge (8). The pair of joints (5) and (6) is holding the first end of the oscillating member (1). The flexible element (7) is holding the second end of the oscillating member (1) and attaches to the frame (4). An air gap (9) is present between the frame (4) and the oscillating member (1). The position of the voice coil is centered over the width of the oscillating member and is in the area of the center of percussion of the entire oscillating member about the axis of the joints (5) and (6) in one alternative to the preferred embodiment of the invention. The vibration, induced either way to the oscillating member will not be transferred into the pair of joints (5)-(6) according to the principle of “The Center of Percussion”. It looks as if the vibration is not affected by the presence of this pair of joints, which is actually the case. In dynamic terms this translates into the fact that the loudspeaker can function without the pair (5)-(6) of joints, which means that the flexible element (7) is the only reaction introduced from the frame (4) into the oscillating member besides the voice coil. The only function of the flexible element (7) is the alignment of the voice coil inside the magnet. This means that the oscillating member finds itself in an almost ideal condition, that of free floating.

FIG. 1b is showing the position of the joint (6).

FIG. 1c is showing the alignment of the voice coil (2) inside the magnet (3). The joint (5) can also be seen.

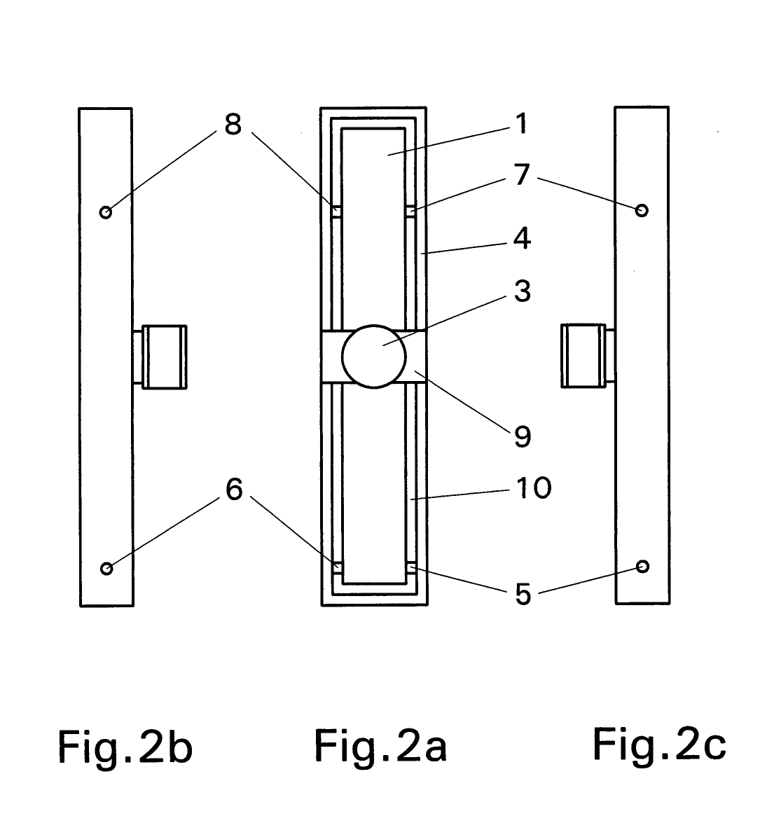

FIG. 2a is showing the rear view of a loudspeaker or a microphone in which the oscillating member (1) is attached to the solid frame (4) by means of two pairs of joints, (5)-(6) and (7)-(8). In all the rest of its surrounding the oscillating member is separated from the solid frame through the air gap (10). The voice coil is attached to the oscillating member (1) in this particular case in the area of the center of mass of the entire oscillating member. The magnet (3) is mounted on the bridge (9), which is mounted onto the frame (4). The first end of the oscillating member is suspended between the pair (5)-(6) of joints. The second pair, (7)-(8), of joints is attached to the oscillating member (1) along the line of the center of percussion of the part of the oscillating member between the center of mass of the entire oscillating member and the second end of the oscillating member, about the axis of the center of mass of the entire oscillating member. In this case, according to the principle of “The Center of Percussion”, the center of mass of the entire oscillating member will not move, which brings about the fact that the entire oscillating member in its instantaneous translation movement induced by the voice coil will tend not to move. From the dynamic point of view it seems like the entire oscillating member is “frozen” in place. The oscillating member (1) will act upon the pair of joints (5)-(6) and (7)-(8) in a very particular way, that is, for every one movement of the voice coil, there will be the same qualitative movement tendency in the opposite direction into the pair of joints (5)-(6) and also in the pair of joints (7)-(8). The reaction of the pair of joints (5)-(6) and (7)-(8) will be equal in quantity, but opposite to the action of the oscillating member, which means that the two pairs of joints in question will act upon the oscillating member as two virtual voice coils in opposition of phase with the physical voice coil, improving the efficiency of the loudspeaker and balancing exceptionally the pickup capabilities of the microphone.

FIG. 2b is showing the joints (6) and (8).

FIG. 2c is showing the joints (5) and (7).

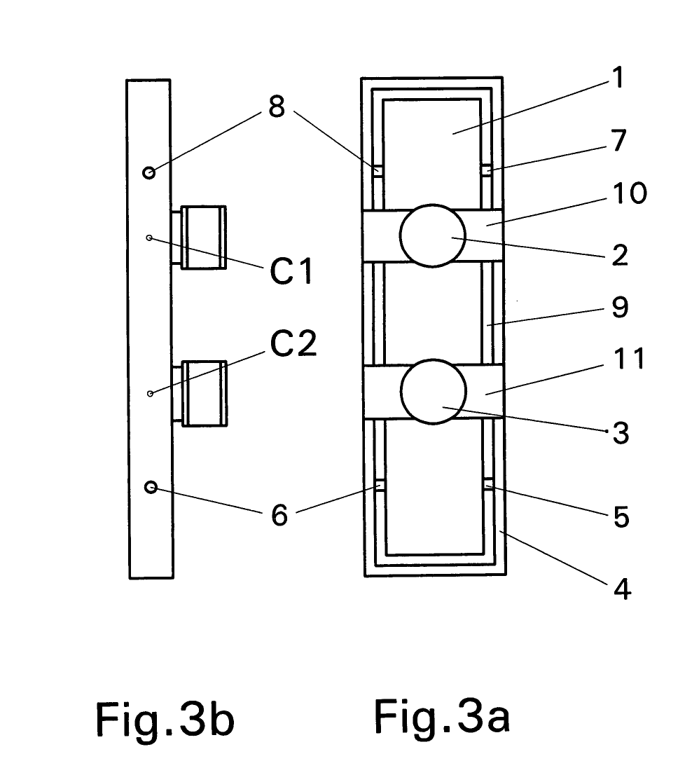

FIG. 3a is showing a loudspeaker or a microphone with two actuators. The oscillating member (1) attaches to the frame (4) through two pairs of joints (5)-(6) and (7)-(8). The center of the voice coil inside the magnet assembly (3) finds itself along the width of the oscillating member (1) in the axis of the center of percussion of the entire oscillating member (1), about the axis of the upper end of the oscillating member. The voice coil inside the magnetic assembly (2) finds itself along the width of the oscillating member (1), in the area of the axis of the center of percussion of the entire oscillating member (1) about the axis of the lower end of the oscillating member (1). The pair (5)-(6) of joints finds itself along the line crossing the width of the oscillating member (1) through the center of mass of part of the oscillating member (1) between the center of the voice coil inside the magnetic assembly (3) and the lower end of the oscillating member (1). The pair (7)-(8) of joints finds itself along the line crossing the width of the oscillating member (1) through the center of mass of the part of the oscillating member (1), between the center of the voice coil inside the magnetic assembly (2) and the upper end of the oscillating member (1). The air gap (9) is separating the rest of the oscillating member (1) from the solid frame (4). The magnet (2) is mounted on the bridge (10), which is attached to the frame (4). The magnet (3) is mounted on the bridge (11), which is attached to the frame (4).

FIG. 3b is showing the position of the joints (6) and (8), as well as the position of the two centers C1 and C2 of the two voice coils.

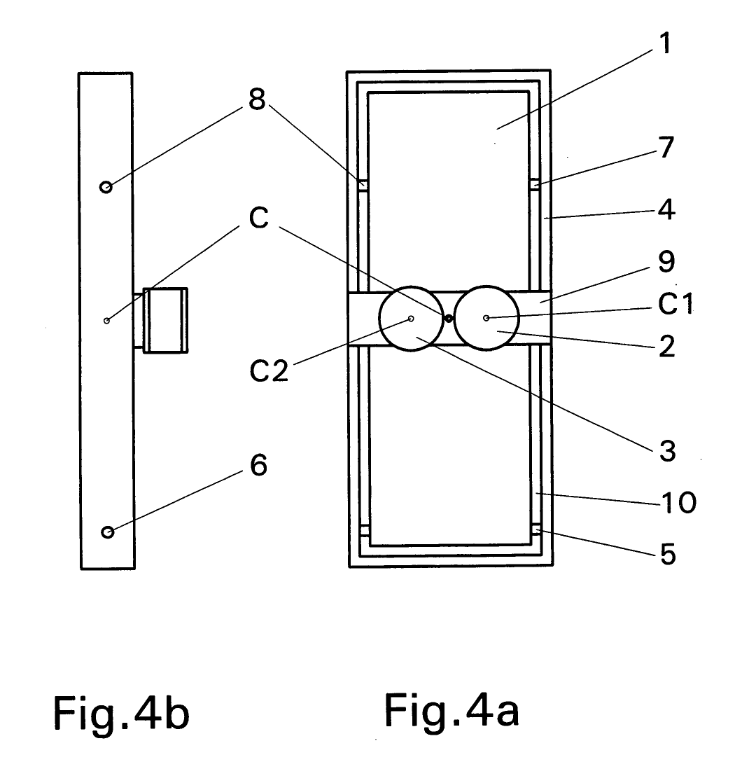

FIG. 4a is showing an electromechanical transducer, in particular a loudspeaker or a microphone, having two actuators, in this case of the dynamic type, (2) and (3) in a row along the width of the oscillating member (1), mounted on the same bridge (9).

The oscillating member (1) is attached to the solid frame (4) through two pairs of joints (5)-(6) and (7)-(8). An air gap (10) is separating the rest of the oscillating member (1) from the frame (4). The centers C1 and C2 of the voice coils, lined up in the magnets (2) and (3), are attached along the width of the oscillating member (1) in a line through the center of mass of the entire oscillating member (1). The pair (5)-(6) of joints is suspending the oscillating member (1) around the lower end of it. The pair (7)-(8) of joints is holding the oscillating member (1) on the line of the center of percussion of the upper half of the oscillating member (1) about the line along the width of the oscillating member (1) through the center C, which is the center of mass of the entire oscillating member (1).

FIG. 4b is showing the position of the joints (6) and (8) and the center of mass C of the entire oscillating member (1).

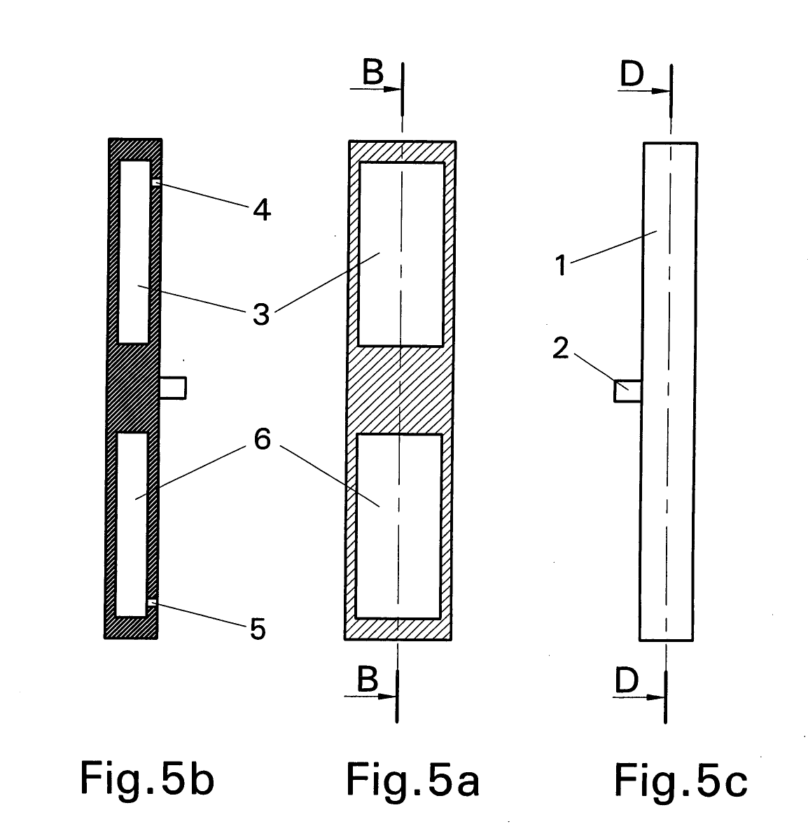

FIG. 5a is showing cavities (3) and (6) of the oscillating member (1) removed from a loudspeaker.

FIG. 5b is showing the small diameter holes (4) and (5) that allow the cavities (3) and (6) to communicate with the outside atmosphere in order to equalize pressures or to enable, before being plugged, to create vacuum inside of them. The inside shape in cross section of the cavities can also be seen.

FIG. 5c is showing the voice coil (2) attached to the oscillating member (1) of a loudspeaker.

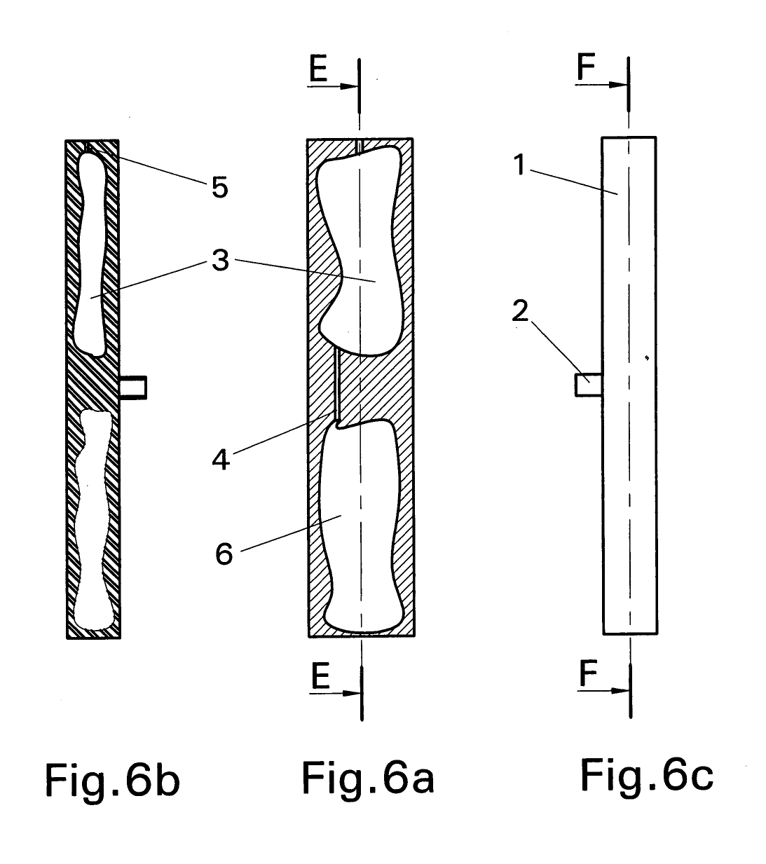

FIG. 6a is showing a cross section of the oscillating member of a loudspeaker. The small diameter hole (4) is connecting the cavities (3) and (6).

FIG. 6b is showing the tube (5) used to fill the cavities (3) and (6) with gas or to create a certain degree of vacuum inside of them. The inside shape of the cavities can also be seen.

FIG. 6c is showing the voice coil (2) attached to the oscillating member (1).

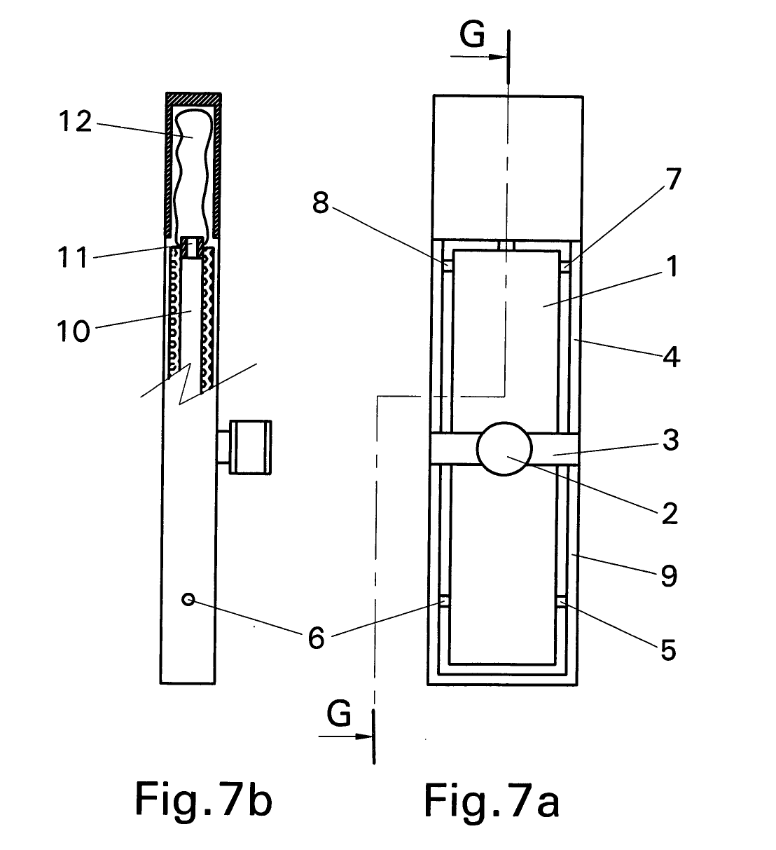

FIG. 7a is showing a loudspeaker built with the oscillating member (1) shown in FIG. 6a. The oscillating member (1) is suspended between two pairs of joints (5)-(6) and (7)-(8). The pair (7)-(8) of joints is holding the upper end of the oscillating member (1). The second pair (5)-(6) of joints is placed in the area along the width of the oscillating member (1) through the center of percussion of the lower half of the oscillating member (1) about the center of mass of the entire oscillating member (1). The magnet (2) is seen as attached to the bridge (3), which is mounted onto the frame (4). The air gap (9) finds itself between the oscillating member (1) and the frame (4).

FIG. 7b is showing the position of the joints (6). The bladder (12) is attached to the tube (11) and communicates with cavity (10). The bladder in its enclosure can hold about 35% of the total volume of the cavities of the oscillating member and is meant to take up the volume change of the gas inside the cavities due to temperature change.

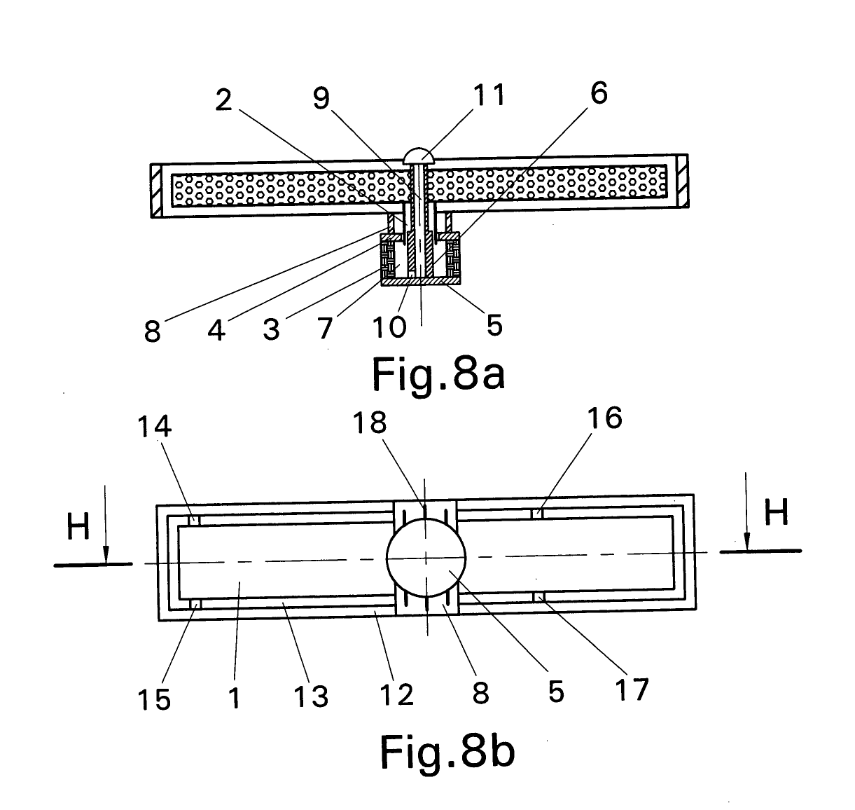

FIG. 8a is showing a loudspeaker in a horizontal position. The voice coil (2) fits in the gap of the flange (4) on the magnet (3) mounted on the bridge (8). The magnet (3) is attached to the flange (4) and (5) creating the cavity (7). The central part (6) of the magnet assembly extends to the front side of the loudspeaker. The opening (9) communicates with the cavity (7) through the opening (10). The decorative plug (11) closes the opening (9). The cavity (7) is filled with fluid in order to increase the cooling capacity of the voice coil. In an alternative embodiment of the invention, a cooling gas like air can be injected into the opening (9) and through the opening (10) into cavity (7). As a consequence the voice coil (2) will find itself in a flow of cooling gas which is exhausted around the tube delimitating cavity (9)

FIG. 8b is showing the oscillating member (1) of the loudspeaker described in FIG. 8a. The flange (5) of the magnet assembly can be seen. The fins (18) of the heat sink can be seen as being part of the bridge (8) itself. The air gap (13) finds itself between the oscillating member (1) and the frame (12). The pairs of joints (14)-(15) and (16)-(17) are suspending the oscillating member (1) inside the frame (12). In an alternative to the preferred embodiment, the voice coil is mounted in the center of mass of the entire oscillating member (1). The pair (14)-(15) of joints is suspending the oscillating member (1) at its first end. The pair (16)-(17) of joints is mounted on the line along the width of the oscillating member (1) through the center of percussion of the second half of the oscillating member about the line along the width of the oscillating member (1) through the center of mass of the entire oscillating member (1).

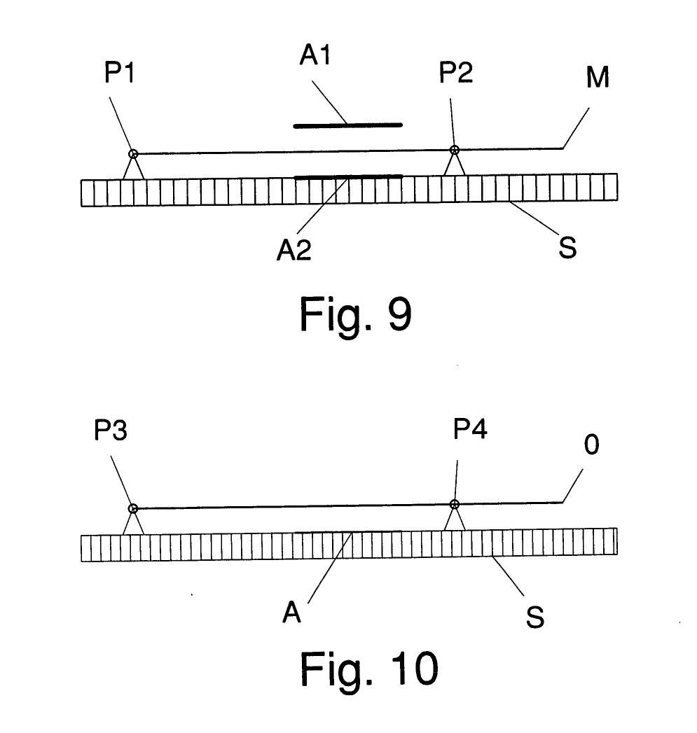

The capacitor type transducer, shown in cross-section in FIG. 9, either loudspeaker or microphone, has an electric conductive membrane M placed between the armatures A1 and A2 of a capacitor.

The polarization between plates A1 and A2 will create the electrostatic field necessary to drive the membrane, which conducts the incident electric current in case of a loudspeaker. A microphone will have the membrane induce current. The two joints P1 and P2 in the case of this transducer are supporting the membrane M along the line of its width. The armatures A1 and A2, as well as the joints P1 and P2, are mounted on the supporting structure S.

The set of armatures A1 and A2 can face the entire surface of the membrane or can target areas of interest as the area around the line of the center of mass of the entire membrane across the width of the membrane M. The joint P1, in an alternative to the preferred embodiment of the invention, is in the area of the first end of the membrane M. The joint P2 is in this case in the area of the center of percussion of the entire membrane about the axis of the joint P1.

FIG. 10 is showing a section across a capacitor type transducer having one polarized armature A mounted on the supporting structure S of the joints P3 and P4. The oscillating member O is held by the joints P3 and P4 along the line of its width and represents the second armature of the capacitor. The oscillating member O, in case of a microphone, due to its movement will change the electric capacity of the assembly, fact picked up by the electric circuit following it. The armature A can cover the entire area of the oscillating member or just selected areas of the oscillating member like the area around the line of the axis along the width of the oscillating member through the center of mass of the entire oscillating member. In an alternative to the preferred embodiment of the invention the joint P3 is attached to the oscillating member O in the member's first end. The joint P4 is holding the oscillating member O on the line of the center of percussion of the entire oscillating member about the line of the joint P3.

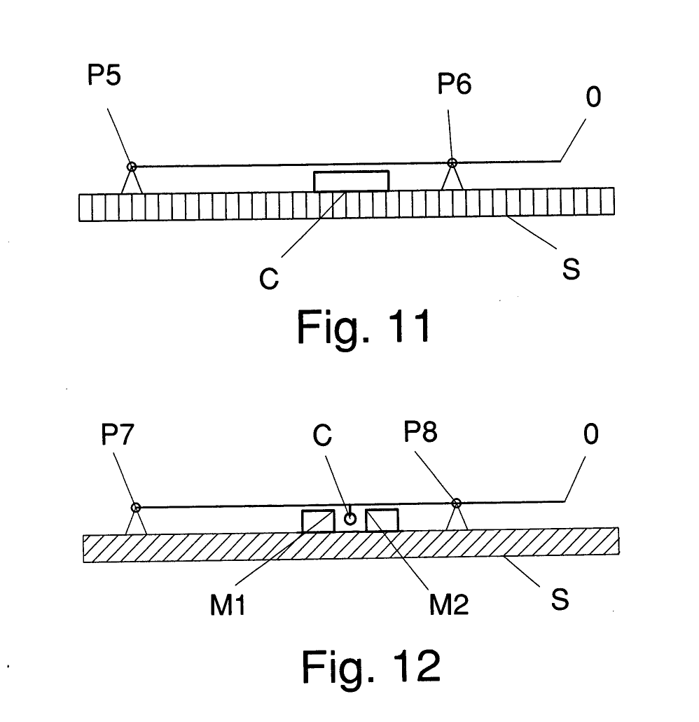

FIG. 11 is showing a magnetic type microphone, where the oscillating member O is made of magnetic permeable material. The mechanical vibration of the oscillating member is transformed in electrical oscillation by the pickup coil C. The coil in this case is not attached to the oscillating member. The oscillating member is supported by the joints P5 and P6 along the line of its width. The pickup coil C, as well as the joints P5 and P6 are mounted on the supporting structure S. In an alternative to the preferred embodiment of the invention, the joint P5 is placed in the area of the first end of the oscillating member. The joint P6 is placed in the area of the line through the center of percussion of the entire oscillating member, along the width of the oscillating member O, about the axis of the joint P5. The pickup coil assembly C is placed in this case in the area of the line through the center of mass of the entire oscillating member along the width of the oscillating member O.

In FIG. 12, the ribbon type transducer, either loudspeaker or microphone, shows the oscillating member O mounted over the line of its width on two joints P7 and P8. These two joints, as well as the two rows of magnets M1 and M2 are mounted on the supporting structure S. The electrical conductor C is attached along the entire width of the oscillating member O and finds itself in the field of the magnetic assembly M1-M2. The joint P7, in an alternative to the preferred embodiment of the invention, is placed in the area of the line of the first end of the oscillating member O. The joint P8 is placed in the area of the line along the width of the oscillating member of the center of percussion of the entire oscillating member about the line of the joint P7. The electrical conductor C finds itself in line with the center of mass of the entire oscillating member O.

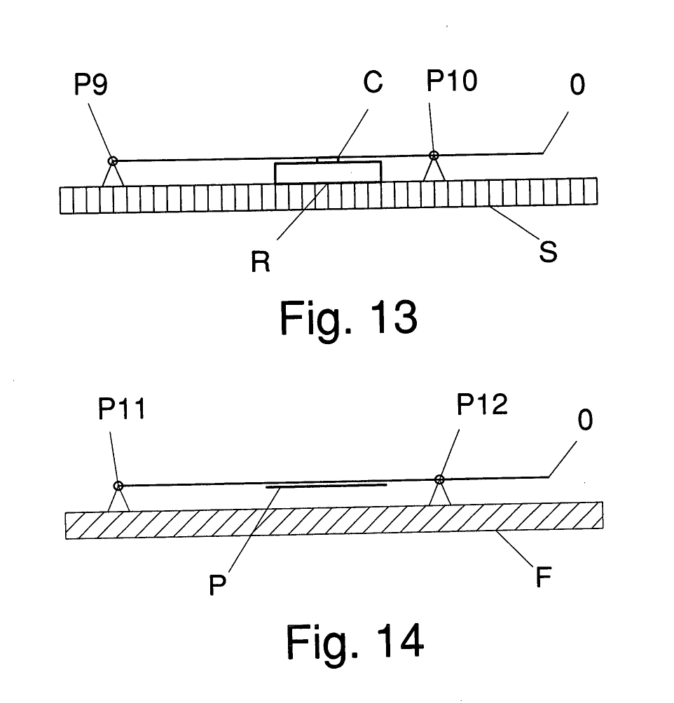

FIG. 13 is a cross-section of a resistive type microphone having the oscillating member O mounted along the line of its width on two joints P9 and P10. The two joints P9 and P10, as well as the resistive element R, containing in general carbon particles, and the two joints P9 and P10 are attached to the supporting structure S. The oscillating member O transmits the vibration to the resistive element R through the connecting element C. In an alternative to the preferred embodiment of the invention, the joint P9 is placed in the area of the line of the first end of the oscillating member O.

The joint P10 stands in the area of the line along the width of the oscillating member O through the center of percussion of the entire oscillating member about the line of the joint P9. The resistive element R is attached by means of the connector C onto the oscillating member on the line across the width of the oscillating member O, through the center of mass of the entire oscillating member.

The side view of the piezoelectric transducer, loudspeaker or microphone, in FIG. 14 shows the oscillating member O mounted on the joints P11 and P12 along the line of its width. These two joints are attached to the frame F. The piezoelectric crystal on its supporting structure can be attached to the entire oscillating member or just parts of the oscillating member in areas of interest. In an alternative to the preferred embodiment of the invention, the joint P11 is placed in the area of the first end of the oscillating member, while the joint P12 is set in the area of the line across the oscillating member through the center of percussion of the entire oscillating member around the line of the joint P11. The piezoelectric crystal in this case is attached to the oscillating member O in an area around the line across the width of the oscillating member O through the center of mass of the entire oscillating member O.

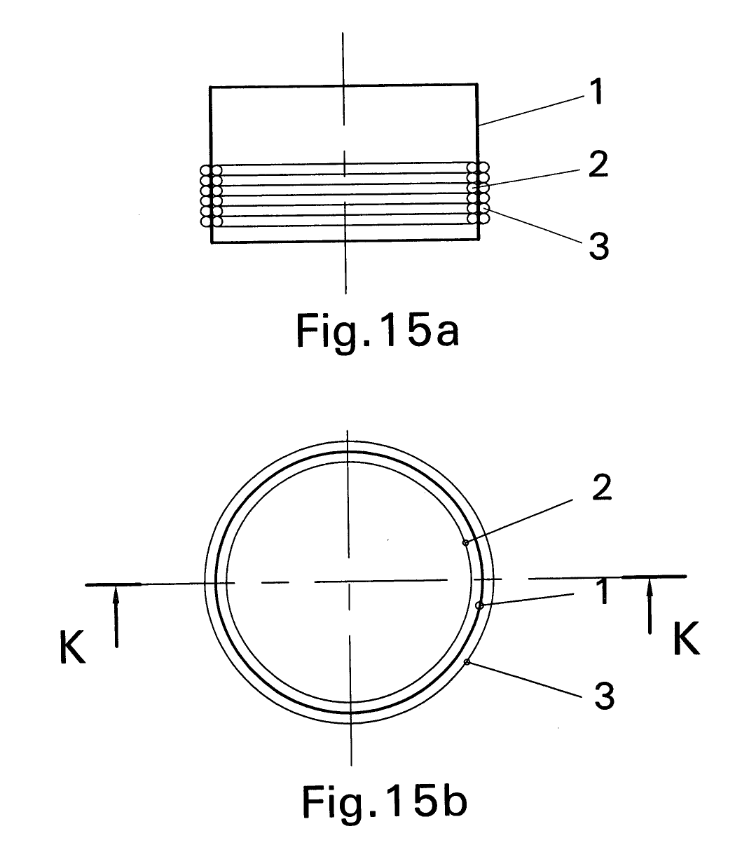

The cross section of the voice coil assembly in FIG. 15a is showing the voice coil form, so called former (1) being retained between the coil layers (2) and (3) as an alternative to the preferred embodiment of the invention.

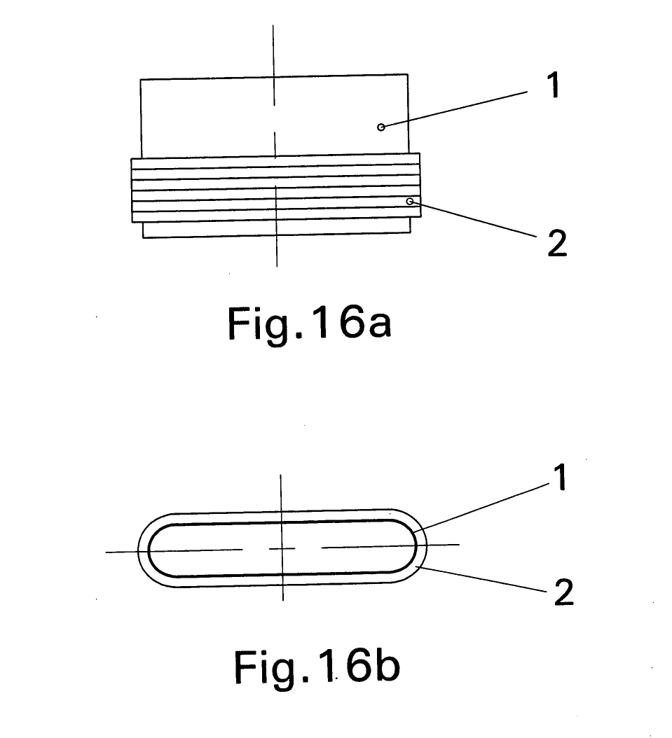

FIG. 15b, as a top view of the voice coil assembly from FIG. 15a, is showing the all around layering of the voice coil form, so called former, (1) between the two successive coil layers (2) and (3). The voice coil of a dynamic loudspeaker or microphone is seen in FIG. 16a, having the coil form (1) surrounded by the coil winding (2). The out of circular shape of this voice coil can be seen in FIG. 16b, as the top view of FIG. 16a and representing an alternative to the preferred embodiment of the invention.

I claim as my invention:

1. A loudspeaker, as a transducer of mechanical oscillations from an actuator to a driven oscillating member or membrane, and a microphone, as a transducer of mechanical oscillations from an oscillating member or membrane to an actuator, as described below:
the actuator in case of the loudspeakers can be of electromechanical type meaning the transferring of electrical energy into mechanical energy;
the actuator in case of the loudspeakers can also be of pure mechanical nature, meaning a transfer of mechanical to mechanical energy, making the loudspeaker an only coupler of mechanical to mechanical oscillations into the medium where oscillations are to be propagated;
the actuator in case of the microphones can be of electromechanical type, meaning the transformation of mechanical energy into electrical energy, or the transformation of mechanical oscillations into equivalent electrical oscillations in case of the resistive microphone;
the actuator in case of the microphones can also be of any mechanical nature facilitating the transfer of mechanical oscillations of the oscillating member or membrane to a mechanical, electromechanical or magneto-mechanical receiving device;
the oscillating member or membrane can be a film, a sheet, a plate or a body of regular or irregular shape made of any single material or composite material that can hold its form;
a loudspeaker or a microphone, having the oscillating member or membrane held between a number of joints or by a single joint attached to a supporting structure and its at least one actuator mounted on the same supporting structure;
these joints can be pivots, rigid or flexible elements mounted in general facing each other along lines of so called interest;
these joints can also be a flexible supporting element, or elements, part of the oscillating member or membrane or a separate supporting entity; attaching or resting the oscillating member or membrane on the supporting structure along parts of the perimeter or the entire perimeter of the oscillating member;
the separate supporting entity of the oscillating member or membrane can be of mechanical type, magnetic type or fluid type, like a gas or liquid filled bladder or a gas or liquid bearing or floating device;
these joints can also be one or more brackets across the front side or rear side, or front and rear side of the oscillating member or membrane, supporting the oscillating member or membrane along a line or in a point or points of so called interest, or in a combination of point, points, line or lines of so called interest;
the oscillating member or membrane can be a film, a sheet, a plate or a body of regular or irregular shape;
the position of at least one actuator and the pattern of the point, points, line, or lines along which the oscillating member or membrane is attached to the supporting structure is following the principle of the “Center of Percussion” about at least one axis considered of rotation, applied to parts of the oscillating member or membrane or to the entire oscillating member or membrane, along any direction or directions;
in case the oscillating member or membrane is supported by a flexible supporting element along parts of its perimeter or along its entire perimeter, the relative to each other positions of the actuator, center of mass and very geometric parameters of the oscillating member or membrane are placed following the principle of “The Center of Percussion” about at least one axis considered of rotation applied to parts of the oscillating member or membrane or to the entire oscillating member or membrane, along one, two or three nonparallel directions, meaning along a single, double or triple coordinate system;
the relative position of at least one actuator and the holding pattern of the joints along the oscillating member or membrane is consistent with the static and/or dynamic equilibrium of the oscillating member or membrane, consisting to execute a rotation about at least one axis;
the actuator can be of dynamic type, mainly a round coil on a round coil form or a coil former placed in a magnetic field of a magnetic assembly, as a dynamic loudspeaker or dynamic microphone component;
the actuator can be of a electrical capacitor type, as a capacitor-type loudspeaker or electrical capacitor microphone component;
the actuator can be of the resistive type mainly like a resistive microphone component;
the actuator can be of the piezoelectric type, mainly like a piezoelectric loudspeaker or a piezoelectric microphone component;
the actuator can be of the magnetic type, mainly a magnetic microphone component;
the actuator can be of the ribbon type, mainly a ribbon loudspeaker or ribbon microphone component;
lines, called of interest, are lines across the considered width of the oscillating member or membrane through the area of the edges or the area of the ends of the oscillating member or membrane, lines through the area of the center of mass of the entire oscillating member or membrane or lines through the area of the centers of mass of parts of the oscillating member or membrane;
lines, called of interest can be the line or lines through the area of the axis of considered rotation or rotations about which the center or centers of percussion are being considered for the entire oscillating member or membrane or parts of the oscillating member or membrane;
lines, called of interest, are the line or lines through the area of the center or centers of percussion associated with the entire oscillating member or membrane or parts of the oscillating member or membrane considered about the corresponding one axis or multiple axis of rotation of the entire oscillating member or membrane or parts of the oscillating member or membrane;
lines, called of interest are the line or lines through the center, called of equal moments of inertia, around which the moments of inertia about the very center of the adjacent parts equalize, considering the movement of the parts as an assembly to be of translation, while the individual adjacent parts are considered to execute rotations around that very center in opposite directions relative to each other;
to increase the width of the oscillating member two or more actuators can be mounted along the same line or lines of interest;
the actuator can be mounted along any line of interest;
at least one joint can be mounted along any line of interest including the lines through the ends of the oscillating member;
the actuator or actuators can switch position with any of the joint or joints;
two or more transducers of the same type or different type can be chained by having them share at least one of their elements, or by connecting them to each other or overlapping part of their elements or overlapping all of their elements forming assemblies;
the overhanging parts of the oscillating member or membrane can be replaced by dynamic and/or static equivalent elements;
the oscillating member or membrane can have at least one cavity filled with air or a fluid different from air;
the oscillating member or membrane can have at least one cavity where a certain degree of vacuum is created;
a loudspeaker that allows its actuator to retain a nonmagnetic fluid in order to insure superior cooling;
a loudspeaker having its dynamic actuator enabled to retain a nonmagnetic fluid in order to insure superior cooling of its coil;
a loudspeaker having its dynamic actuator coil in a stream of cooling fluid, in particular air;
a dynamic type loudspeaker or microphone having the voice coil assembly in a noncircular shape;
a dynamic type loudspeaker having the coil form or coil former retained between at least two layers of its coil winding;

2. A transducer, as described in claim 1, having its oscillating member supported in the following way:
the first joint or set of joints is placed in the area of line of the first end of the oscillating member and the second joint or set of joints is placed in the area of the line of the second end of the oscillating member;

3. A transducer, as described in claim 2, having the actuator placed in the area of the line of the center of percussion of the entire oscillating member about the line of the first joints or set of joints;

4. A transducer, as described in claim 2, having the actuator placed in the area of the line of the center of mass of half of the mass of the entire oscillating member towards one end of the oscillating member.

5. A transducer, as described in claim 2, having the line of the actuator in the area of the line of the center of equal moments of inertia of the part of the oscillating member towards one end of the oscillating member, between the line of that very end of the entire oscillating member and the line of the center of equal moments of inertia of the entire oscillating member, considered to execute a movement of translation.

6. A transducer, as described in claim 2, having the line of the actuator in the area of the line of the center of percussion about the line of the center of mass of the entire oscillating member, of the part of the oscillating member, between the center of mass of the entire oscillating member and one of the ends of the oscillating member.

7. A transducer, as described in claim 2, having the line of the actuator in the area of the center of percussion about the center of equal moments of inertia of the entire oscillating member, of the part of the oscillating member, between the center of equal moments of inertia of the entire oscillating member and one of the ends of the entire oscillating member.

8. A transducer, as described in claim 2, having the line of the actuator in the area of the line of the center of percussion of part of the oscillating member between the center of percussion of the entire oscillating member about the first end of the entire oscillating member, and the second end of the entire oscillating member, about the line of the center of percussion of the entire oscillating member about the line of the first end of the entire oscillating member.

9. A transducer, as described in claim 2, having two actuators positioned as follows:
a first actuator is placed in the area of the line of the center of percussion of part of the oscillating member or membrane between the center of mass or the center of equal moments of inertia of the entire oscillating member or membrane and the line of the area of the first joint or joints, about the center of mass or the center of equal moments of inertia of the entire oscillating member or membrane;
a second actuator is placed in the area of the line of the center of percussion of part of the oscillating member or membrane between the center of mass or the center of equal moments of inertia of the entire oscillating member or membrane and the line of the area of the second joint or joints, about the center of mass or the center of equal moments of inertia of the entire oscillating member or membrane;

10. A transducer as described in claim 1 having the first end of the oscillating member supported by a first joint or set of joints and the second end free floating;

11. A transducer, as described in claim 10, having the second joint or set of joints supporting the oscillating member in the area of the line of center of mass of the part of the entire oscillating member between the center of mass of the entire oscillating member and the second end of the entire oscillating member;
the actuator is placed in the area of the center of mass of the entire oscillating member;

12. A transducer, as described in claim 10, having the second joint or set of joints supporting the oscillating member in the area of the center of equal moments of inertia of the part of the entire oscillating member between the center of equal moments of inertia of the entire oscillating member and the second end of the entire oscillating member;
the actuator is placed in the area of the line of the center of equal moments of inertia of the entire oscillating member;

13. A transducer, as described in claim 10, having the second joint or set of joints supporting the oscillating member in the area of the line of the center of percussion of the part of the entire oscillating member between the center of mass of the entire oscillating member and the second end of the entire oscillating member, about the line of the center of mass of the entire oscillating member;
the actuator is placed in the area of the line of the center of mass of the entire oscillating member.

14. A transducer, as described in claim 10, having the line of the second joint or set of joints supporting the oscillating member in the area of the line of the center of percussion of the part of the entire oscillating member between the center of equal moments of inertia of the entire oscillating member and the second end of the entire oscillating member, about the line of the center of equal moments of inertia of the entire oscillating member;
the actuator is placed in the area of the line of the center of equal moments of inertia of the entire oscillating member.

15. A transducer, as described in claim 10, having the line of the second joint or set of joints supporting the oscillating member in the area of the line of the center of percussion of the part of the entire oscillating member between the center of percussion of the entire oscillating member about the first joint or set of joints and the second end of the entire oscillating member, about the center of percussion of the entire oscillating member about the first joint or set of joints;
the actuator is placed in the area of the line of the center of equal moments of inertia of the entire oscillating member.

16. A transducer, as described in claim 10, having the line of the second joint or set of joints supporting the oscillating member in the area of the line of the center of percussion of the part of the entire oscillating member between the center of percussion of the entire oscillating member about the first joint or set of joints and the second end of the entire oscillating member, about the center of percussion of the entire oscillating member about the first joint or set of joints;
the actuator is placed in the area of the center of mass of the entire oscillating member.

17. A transducer, as described in claim 1, having both ends of the oscillating member or membrane free floating and two joints or two sets of joints positioned as follows:
a first joint or set of joints is placed along the line of the area of the center of percussion of part of the oscillating member or membrane between the center of mass or the center of equal moments of inertia of the entire oscillating member or membrane and the line of the area of the first end of the entire oscillating member or membrane, about the center of mass or the center of equal moments of inertia of the entire oscillating member or membrane;
a second joint or set of joints is placed along the line of the area of the center of percussion of part of the oscillating member or membrane between the center of mass or the center of equal moments of inertia of the entire oscillating member or membrane and the line of the area of the second end of the entire oscillating member or membrane, about the center of mass or the center of equal moments of inertia of the entire oscillating member or membrane;
the actuator is placed in line with the area of the center of mass or the center of equal moments of inertia of the entire oscillating member or membrane.

18. A transducer, as described in claim 1, being an assembly of at least two transducers sharing at least one of their elements, in this case, the actuator, having their elements positioned as follows:
the two transducers have their oscillating members or membranes crossing each other and coupled through their common element, in this case, the actuator;
the supporting structures of both transducers are connected;
the first transducer has a first joint or set of joints placed along the line of the area of the first end of its oscillating member or membrane;
a second joint or set of joints of the first transducer is placed along the line of the center of percussion about the center of mass or the center of equal moments of inertia of its entire oscillating member or membrane of the part of the oscillating member or membrane between the center of mass or the center of equal moments of inertia of the entire oscillating member or membrane and the second end of the oscillating member or membrane;
the common actuator is placed on the first transducer in the center of mass or in the center of equal moments inertia of its entire oscillating member or membrane;
the second transducer has a first joint or set of joints placed along the line of the area of the first end of its oscillating member or membrane;
a second joint or set of joints of the second transducer is placed along the line of the center of percussion about the center of mass or the center of equal moments of inertia of its entire oscillating member or membrane of the part of the oscillating member or membrane between the center of mass or the center of equal moments of inertia of the entire oscillating member or membrane and the second end of its oscillating member or membrane;
the common actuator is placed on the second transducer in the area of the center of mass or in the area of the center of equal moments of inertia of its entire oscillating member or membrane.
